(19) United States
(12) Patent Application Publication
(10) Pub. No.: US 2011/0038678 A1
(43) Pub. Date: Feb. 17, 2011

(54) Seismic tool assembly for use in anchor insertion

(76) Inventor: Robert Cousineau, Ottawa (CA)

Correspondence Address: Robert Cousineav, P.O.Box 8341, Station "T", Ottawa, ON, K1G 3H8, CA

(21) Appl. No.: 12/585,523

(22) Filed: Sep. 17, 2009

(30) Foreign Application Priority Data
Aug. 11, 2009 (CA) 2674651

(51) Int. Cl. B23B 41/00; B23B 45/14

(52) U.S. Cl. 408/81; 408/241 R

(57) ABSTRACT

A seismic tool assembly for effecting a drill hole and enlarging a lowermost end thereof whereby an anchor can be set more securely therein. A drill bit is inserted through an opening in a stabilizer, which is positioned over a surface where the drill hole is to be made. The bit is placed into the drill hole, attaining a position at the lowermost end thereof. The lower end of the bit has a cutting portion having a cutting radius greater than that of the bit body whereby, when the bit is inserted fully into a lowermost end of the hole and rotated, the cutting portion enlarges the lowermost end of the hole, whereby flanged portions of an anchor will rest within the enlarged area, retaining the anchor in place. The stabilizer has a flanged portion extending into the hole, which provides a space between the bit and the stabilizer to permit limited tilting movement of the bit during drilling to enlarge a lowermost end of the hole, and for aiding in accurately inserting the bit into position.

The present invention relates to a seismic tool assembly meant to be used for the later insertion and setting of anchors, such as drop-in and wedge type anchors into brittle materials such as concrete, stone, masonry and cementuous materials. More particularly, the present invention relates to a seismic tool assembly for effecting a drill hole and enlarging a lowermost end thereof to have a greater circumference than that of the remainder of the drill hole whereby an anchor can be set more securely therein.

### BACKGROUND OF THE INVENTION

Anchors are conventionally used in construction to attach various components of a building construction to an overhead ceiling or other structure. Such components to be attached can relate to, for example, services that provide plumbing, electrical, drainage, sprinkler system piping and drop ceilings. From these anchors, which are usually of the wedge or drop-in type variety, all of the above services and ceilings are suspended or secured.

Conventionally, in setting anchors in concrete to suspend an awning, for example, a hole is pre-drilled in the surface to which the anchor is to be applied, and then the anchor is inserted into the pre-drilled hole. However, when setting such anchors in concrete it is not uncommon for such anchors to weaken and loosen over time, particularly in situations where cracking or chipping of the concrete around the pre-drilled hole has occurred.

Furthermore, studies have revealed that cracking can typically occur in the concrete element, and that such cracks can significantly impact the performance of anchors. Cracks can originate on a concrete beam or slab in a variety of ways, such as creep, temperature settlement of the support or foundation, thermal expansion and contraction stress overload, or from a natural disaster such as an earthquake or flood. In such situations, the situation can arise where, if one such concrete anchor fails and lets go, the remaining anchors, by virtue of the weight they additionally assume in light of such failure, can also similarly collapse and fail.

It has been found that enlarging the lowermost (interior) portion of a drill hole can allow an anchor to be set more securely therein. It has further been found that providing a drill hole with an enlarged lower end having a greater circumference than that of the remainder of the drill hole can be advantageously provided by a drill bit having an enlarged cutting portion adjacent the tip, which is inserted into the drill hole, whereby the enlargement of the cutting portion is configured so that it can pass through the shaft of the pre-drilled hole to be enlarged.

It would therefore be advantageous to have an improved seismic tool assembly meant to be used for the later insertion and setting of anchors into brittle materials such as concrete, stone, masonry and cementuous materials.

It would be further advantageous to have an improved seismic tool assembly for use in a one step process for both creating a drill hole and, at the same time, enlarging a lowermost end of a drill hole, wherein the lowermost end of the drill hole can be further drilled and enlarged to have a greater circumference than that of the remainder of the drill hole, wherein an anchor can later be positioned and securely retained within the enlarged area.

It would also be further advantageous to have an improved seismic tool assembly meant to be used for the later insertion and setting of anchors which utilizes a stabilizer for mounting within at least a portion of the drill hole, and having an opening corresponding with the drill hole for receiving an insertion of the bit body into the drill hole, so as to aid in accurately inserting the drill bit into the drill hole. To this end, the present invention effectively addresses this need.

### SUMMARY OF THE INVENTION

The present invention provides an improved seismic tool assembly meant to be used for the later insertion and setting of anchors for the insertion and setting of anchors into brittle materials such as concrete, stone, masonry and cementuous materials.

The present invention also provides an improved seismic tool assembly meant to be used for the later insertion and setting of anchors, which can be used in a one step process for both creating a drill hole and, at the same time, for enlarging a lowermost end of a drill hole to have a greater circumference than that of the remainder of the drill hole, whereby an anchor can be later set and positioned more securely therein.

The present invention also provides an improved seismic tool assembly meant to be used for the later insertion and setting of anchors which utilizes a stabilizer for mounting within at least a portion of the drill hole, and having an opening corresponding with the drill hole for receiving an insertion of the bit body into the drill hole, so as to aid in accurately inserting the drill bit into the drill hole.

According to a first broad aspect of an embodiment of the present invention, there is disclosed a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a second cutting portion is positioned to protrude from at least one side of the second end region, the second cutting portion having an operational cutting radius greater than a cutting radius of the bit body; a stabilizer having an opening defined therethrough and being constructed and arranged for mounting within at least a portion of the drill hole, the opening corresponding with the drill hole and for receiving an insertion of the bit body into the drill hole; and a drill stop member mounted upon the stabilizer and having a central opening corresponding with each of the opening of the stabilizer and the drill hole, the drill stop member restricting downward drilling movement of the bit body into the drill hole to a pre-set depth.

According to a second broad aspect of an embodiment of the present invention, there is disclosed a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a second cutting portion is positioned to protrude from at least one side of the second end region, the second cutting portion having an operational cutting radius greater than a cutting radius of the bit body; a stabilizer having an opening defined therethrough corresponding with the drill hole for receiving an insertion of the bit body into the drill hole, the stabilizer having a flange portion constructed and arranged to extend into the drill hole and abut an inside portion thereof, the flange portion providing a space between the bit body and the stabilizer to permit limited tilting movement of the bit body to enlarge a lowermost end of the drill hole; and a drill stop member mounted upon the stabilizer and having a central opening corresponding with each of the opening of the stabilizer and the drill hole, the drill stop member restricting downward drilling movement of the bit body into the drill hole to a pre-set depth.

An important advantage of the present invention is that it provides an improved seismic tool assembly having a drill bit which can be connected to a conventional drill, for effecting a drill hole and enlarging a lowermost end thereof wherein an anchor can later be positioned and securely retained within the enlarged area. Further, the present invention provides a stabilizer for mounting within at least a portion of the drill hole, having an opening corresponding with the drill hole, for receiving an insertion of the drill bit into the drill hole, so as to aid in accurately inserting and positioning the drill bit into the drill hole.

### BRIEF DESCRIPTION OF THE DRAWINGS

The embodiments of the present invention will now be described by reference to the following figures, in which identical reference numerals in different figures indicate identical elements and in which:

FIG. 1 is a side view of an embodiment of the seismic tool assembly of the present invention;

FIG. 2A is a side view of the embodiment of the present invention shown in FIG. 1, illustrating the ability of the drill bit to tilt within the stabilizer to assist in enlarging the lowermost end of the drill hole;

FIG. 2B is a top view of the embodiment shown in FIG. 2A, illustrating the ability of the drill bit to tilt within the stabilizer to assist in enlarging the lowermost end of the drill hole;

FIG. 3 is a side view of another embodiment of the present invention, illustrating the tapering of the bit body;

FIG. 4 is a side view of another embodiment of the present invention, illustrating the flange portion of the stabilizer being tapered at a distal end thereof; and

FIG. 5 is a side view of another embodiment of the present invention, illustrating the drill bit in conjunction with a percussion adapter.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention consists of an improved seismic tool assembly designed for effecting a drill hole and enlarging a lowermost end thereof to have a greater circumference than that of the remainder of the drill hole whereby an anchor can be set more securely therein.

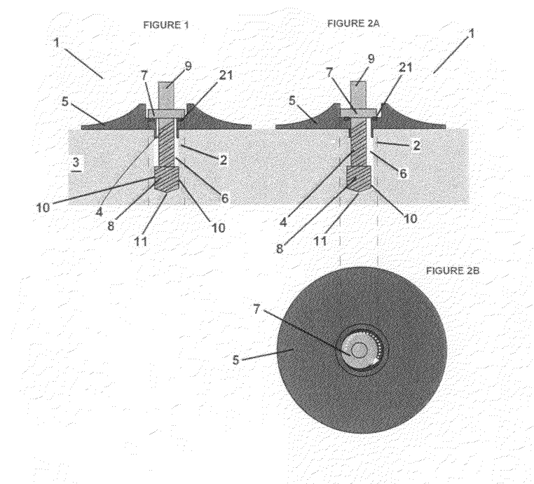

Referring to FIG. 1, there is shown a seismic tool assembly for use in the later insertion and setting of anchors shown generally at 1 in accordance with a first exemplary embodiment of the present invention. In a preferred embodiment, as hereinafter described, the seismic tool assembly 1 is to be rotatably mounted onto a drill by way of a drill spindle (not shown). It will be understood that there are numerous variations as to the types of attachments to a drill or otherwise that the seismic tool assembly 1 of the present invention could be mounted thereon, as would be readily apparent to one skilled in the art.

In a preferred embodiment, the seismic tool assembly 1 is for use in the later insertion and setting of anchors into concrete, stone, masonry and cementuous materials 3 (though it will be understood that other variations to this are possible) and comprises a seismic drilling bit 2, a stabilizer 5, and a drill stop member 7, as hereinafter described.

Preferably, the seismic drilling bit 2 will be made of a durable, machinable metal and is substantially cylindrical in shape. The seismic drilling bit 2 is, preferably, of a one-piece construction that comprises an upper end 9 and a lower end 8 which are integrally connected to one another.

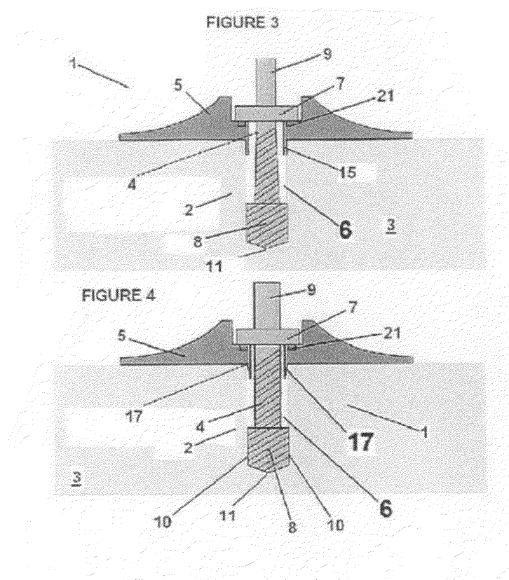

With reference to FIG. 1, it can be seen that the bit body 4 of the seismic drilling bit 2 can effect the drilling of a drill hole, and has a first diameter (and cutting radius) sized to readily fit into the drill hole 6 (as seen in FIG. 3, and as hereinafter described), and possesses, as most conventional drill bits do, at least one cutting edge and at least one groove extending in a helical fashion along a length of the bit body 4 of the seismic drilling bit 2. In a preferred embodiment, these extend along a substantial length of the bit body 4, or, alternatively, extend along at least half a length of the bit body 4. Preferably, the first diameter of the upper end 9 of the bit body 4 is less than or equal to a diameter of the drill hole 6 into which the seismic drilling bit 2 of the present invention is to be inserted.

The proximal upper end 9 of the seismic drilling bit 2 is constructed and arranged to be releasably secured to a drill by way of a drill spindle (not shown). In an alternative embodiment, the distal lower end 8 of the seismic drilling bit 2 can have a tapered end (not shown) and a drill tip 11 extending generally outwardly from the tapered end.

The lower end 8 of the seismic drilling bit 2 has a cutting portion 10 positioned on each side of the lower end 8 of the seismic drilling bit 2, the cutting portions 10 having a greater outermost width than that of the bit body 4 whereby, when the seismic drilling bit 2 is inserted fully into an lowermost end of the drill hole 6 and rotated, the cutting portions 10 enlarge a circumference of the drill hole 6 at the lowermost end thereof that is greater than the circumference of the remainder of the shaft of the drill hole. Preferably, the cutting portions 10 extend outwardly from substantially around an entirety of the lower end 8 of the seismic drilling bit 2, as seen in FIG. 1. In an alternative embodiment, the lower end 8 of the seismic drilling bit 2 can have a cutting portion positioned on only one side of the lower end 8 of the seismic drilling bit 2.

In a still further embodiment (not shown), the bit body 4 of the seismic drilling bit 2 has a diameter (and cutting radius) that is less than that of the drill hole 6, with the cutting portions 10, of course, still having a greater outermost width (and cutting radius) than that of the bit body 4. In this manner, with the bit body 4 of the seismic drilling bit 2 having a width that is less than that of the drill hole 6, the initial insertion of the seismic drilling bit 2 into the drill hole is made easier, whereby the bit does not need to be as readily forcibly inserted.

The stabilizer 5, preferably, has an opening (not shown) defined therethrough, the opening corresponding with the drill hole 6 when the stabilizer 5 is placed in position over the drill hole, and is used for receiving an insertion of the seismic drilling bit 2 into the drill hole 6.

Preferably, the opening in the stabilizer 5 is positioned at a substantially central location of the stabilizer 5, and, as seen in FIGS. 1 and 2A, the central location where the opening is situated is recessed from an upper surface of a remainder of the stabilizer 5. Further, when the stabilizer 5 is placed in position over the drill hole 6 an outermost diameter of the stabilizer 5 is greater than a diameter of the drill hole 6, as can be plainly seen in FIGS. 1-4. The stabilizer 5 aids in the accurate and gradual insertion of the seismic drilling bit 2 into the drill hole 6. In a further embodiment, and with reference to FIGS. 3 and 4, the stabilizer 5 further comprises a flange portion 15 constructed and arranged to extend into the drill hole 6 and abut an inside portion thereof, the flange portion 15 providing a space between the bit body 4 and the stabilizer 5 to permit limited tilting movement of the seismic drilling bit 2 (held in position within the stabilizer) to enlarge a lowermost end of the drill hole 6. In this manner, as the seismic drilling bit 2 is drilling to enlarge a lower end of the drill hole 6, the distance between the stabilizer 5 and the drill bit 2 is enough to further expand a size of the drill hole 6 at the lower end thereof, by allowing the user to gradually tilt the drill bit 2 from its vertical axis (as shown in FIGS. 2A and 2B) while the drilling rotation continues, it being understood that this tilting rotational drilling of the lower end of the drill hole 6 by the drill bit 2 within the stabilizer 5 can be done through 360 degrees. When the drill bit 2 is tilted from its vertical axis, sides of the drill bit 2 will abut against the flange portion 15 of the stabilizer 5, as shown in FIG. 3. It is this extra clearance between the stabilizer 5 and the drill bit 2 that allows a user to tilt the drill bit 2 to create enlarged area 13 at the lower end of the drill hole 6, as shown in FIG. 2A.

In a still further embodiment, the flange portion 15 of the stabilizer 5 is tapered 17 (as shown in FIG. 4) at a distal end thereof so as to further aid in the accurate and gradual insertion of the seismic drilling bit 2 into the drill hole 6.

The seismic tool assembly 1 further comprises, with reference to FIGS. 3 and 4, a drill stop member 7 held in position on the stabilizer 5 by at least one magnet 21 positioned between the drill stop member 7 and the stabilizer 5. Preferably, the drill stop member 7 has a central opening which corresponds with each of the openings of the stabilizer and the drill hole, it being understood that the drill stop member 7 restricts downward drilling movement of the seismic drilling bit 2 into the drill hole 6 to a pre-set depth.

In operation, the seismic drilling bit 2 is to be rotatably mounted onto a drill (not shown), and the seismic drilling bit 2 is inserted through the openings in the drill stop member 7 and the stabilizer 5. The assembly, including the stabilizer 5, is positioned over a surface where a drill hole 6 is to be made. Once the seismic drilling bit 2 is sunk to a pre-set depth and rotated, rotational drilling (and tilted rotational drilling as previously described) by the seismic drilling bit 2 can then be effected in creating enlarged area 13 (shown in FIG. 2A) of the lowermost end of the drill hole 6.

Of course, by virtue of the cutting portions 10 having an outermost width (and operational cutting radius) that is slightly greater than that of the bit body 4 (or of the drill hole 6), these cutting portions 10, when the drilling bit 2 is rotated, enlarge a circumference of the drill hole 6 at the lowermost end (in creating enlarged area 13) that is greater than that of the remainder of the drill hole 6. In this manner, once the enlarged area 13 has been created, and the seismic drilling bit 2 removed from the drill hole 6, the anchor (not shown) can be inserted, and, when the anchors have been flanged outwardly by conventional means within the drill hole 6, the flange portions of the anchor can rest within the enlarged area 13, thus securely retaining the anchor in place.

In a still further embodiment, as shown in FIG. 3, the bit body 4 is tapered, and having a narrower circumference than that of the lowermost end of the bit body. In this manner, the tapered drill bit allows for less physical contact with the stabilizer 5 and increases the range of motion of the seismic drilling bit 2 in permitting limited tilting movement of the bit to enlarge a lowermost end of the drill hole 6. It will also be understood that the drill bit 2 can come in several set depths, or the drill stop member 7 itself could be adjustable through a set screw.

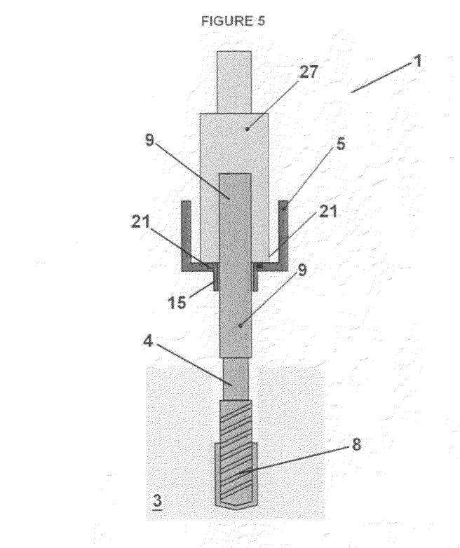

In a still further embodiment, as shown in FIG. 5, the seismic tool assembly 1 further comprises a percussion adapter 27, which is known to workers skilled in the art, and which is constructed and arranged for connection to the upper end 9 of the bit body 4. The percussion adapter 27 is held in position on the stabilizer 5 by at least one magnet 21 positioned between the percussion adapter 27 and the stabilizer 5. It will be understood that the percussion adapter 27 may be modified to have a magnetic surface on the top, the bottom, or both, so as to hold the stabilizer during the drilling process. In this manner, the stabilizer 5 can be pulled down to the concrete to aid in the expansion process.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the invention in which an exclusive property or privilege is claimed are defined as follows:

1. A seismic tool assembly for effecting a drill hole and enlarging a lowermost end thereof for a later insertion and setting of anchors therein, the assembly comprising:
a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body;
a stabilizer having an opening defined therethrough and being constructed and arranged for mounting within at least a portion of the drill hole, the opening corresponding with the drill hole and for receiving an insertion of the bit body into the drill hole; and
a drill stop member mounted upon the stabilizer and having a central opening corresponding with each of the openings of the stabilizer and the drill hole, the drill stop member restricting downward drilling movement of the bit body into the drill hole to a pre-set depth.

2. The assembly as claimed in claim 1, wherein the cutting radius of the bit body is substantially equal to a diameter of the drill hole.

3. The assembly as claimed in claim 1, wherein the cutting radius of the bit body is substantially equal to one-half a diameter of the drill hole.

4. The assembly as claimed in claim 1, wherein the cutting portion extends outwardly from substantially around an entirety of the second end region.

5. The assembly as claimed in claim 1, wherein the at least one cutting edge and the at least one groove extend along a substantial length of the bit body.

6. The assembly as claimed in claim 1, wherein the at least one cutting edge and the at least one groove extend along at least half a length of the bit body.

7. The assembly as claimed in claim 1, wherein the cutting portion is integrally connected to the bit body.

8. The assembly as claimed in claim 1, wherein the drill bit is constructed and arranged for attachment to a power drill.

9. The assembly of claim 1, wherein the drill bit has at least one cutting edge and at least one groove extending in a helical fashion along a length of the bit body.

10. The assembly of claim 1, wherein the second end region of the drill bit has a tapered end and a drill tip extending generally outwardly from the tapered end.

11. The assembly of claim 1, wherein the opening in the stabilizer is positioned at a substantially central location of the stabilizer.

12. The assembly of claim 1, wherein an outermost diameter of the stabilizer is greater than a diameter of the drill hole.

13. The assembly of claim 1, wherein the drill stop member is held in position on the stabilizer by at least one magnet positioned between the drill stop member and the stabilizer.

14. The assembly of claim 11, wherein the opening in the substantially central location of the stabilizer is recessed from an upper surface of a remainder of the stabilizer.

15. The assembly of claim 1, wherein the stabilizer further comprises a flange portion constructed and arranged to extend into the drill hole and abut an inside portion thereof, the flange portion providing a space between the bit body and the stabilizer to permit limited tilting movement of the bit body to enlarge a lowermost end of the drill hole.

16. The assembly of claim 15, wherein the flange portion is tapered at a distal end thereof.

17. The assembly of claim 1, wherein the bit body is tapered, an upper end of the bit body having a narrower circumference than that of the lowermost end of the bit body.

18. A seismic anchor insertion assembly for insertion into a drill hole to effect placement of an anchor, the assembly comprising:
a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body;
a stabilizer having an opening defined therethrough corresponding with the drill hole for receiving an insertion of the bit body into the drill hole, the stabilizer having a flange portion constructed and arranged to extend into the drill hole and abut an inside portion thereof, the flange portion providing a space between the bit body and the stabilizer to permit limited tilting movement of the bit body to enlarge a lowermost end of the drill hole; and
a drill stop member mounted upon the stabilizer and having a central opening corresponding with each of the openings of the stabilizer and the drill hole, the drill stop member restricting downward drilling movement of the bit body into the drill hole to a pre-set depth.

19. The assembly of claim 18, wherein the flange portion is tapered at a distal end thereof.

20. The assembly of claim 18, wherein the assembly further comprises a percussion adapter constructed and arranged for connection to the first end region of the bit body.
